(19) United States
(12) Patent Application Publication
(10) Pub. No.: US 2003/0135481 A1
(43) Pub. Date: Jul. 17, 2003

(54) Rules based method and system for project performance monitoring

(76) Inventors: Philip Helmes, Marblehead, MA (US); Margaret A. Fulenwider, Charlestown, MA (US)

Correspondence Address: MINTZ, LEVIN, COHN, FERRIS,, GLOVSKY and POPEO, P.C., One Financial Center, Boston, MA, 02111, US

(21) Appl. No.: 10/314,678

(22) Filed: Dec. 9, 2002

Related U.S. Application Data
(60) Provisional application No. 60/338,388, filed on Dec. 7, 2001.

(51) Int. Cl. G06F 7/00

(52) U.S. Cl. 707/1

(57) ABSTRACT

The invention is directed to a rules based method and system for monitoring and reporting the status, progress and performance of a project. The invention further includes a method and system which include indicators which are selected as a function the rules to identify variances in the project status, progress and performance. The invention further provides for a dashboard type way of presenting the information which presents the information in the form of indicators that allow a user to determine whether a project or component of a project is not performing as it is expected or planned to perform. The rules according to the invention can define variance limits for the data representative of the project performance and be used to change the indicators as a function of applying the rules to the project data. The invention further contemplates providing method and system in which data received from the data sources and stored in an oversight system that cannot be access or modified by the parties that are the sources of the data, thus providing an independent general ledger for the project data.

### CROSS-REFERENCE TO RELATED APPLICATIONS

This application claims the benefit of priority to U.S. S. No. 60/333,388 filed Dec. 7, 2001, which is incorporated herein by reference in its entirety.

### COPYRIGHT NOTICE

Copyright, 2001, InteCap, Inc. A portion of the disclosure of this patent document contains material which is subject to copyright protection. The copyright owner has no objection to reproduction by anyone of the patent document or the patent disclosure, as it appears in the U.S. Patent and Trademark Office patent file or records, but otherwise reserves all copyright rights whatsoever.

### STATEMENT REGARDING FEDERALLY SPONSORED RESEARCH

Not Applicable

### REFERENCE TO MICROFICHE APPENDIX

Not Applicable

### BACKGROUND OF THE INVENTION

This invention relates to a method and system for monitoring the performance of a project and, more particularly, to a method and system which provides for rules based monitoring and a dashboard like console for reporting the projects progress and performance.

In the field of project management, whether the project is a multi-billion dollar construction project or a small addition or renovation project, the tools that are used in the planning phase to develop the project plan are also typically used in the management phase to oversee that the project proceeds according to that plan. Thus, in the planning phase, the project is broken down into a series of steps or sub-projects which are typically represented on a GANTT chart as the milestones which are used to monitor and report the project's progress in the oversight process. Additional tools such as electronic spreadsheets and graphs are also used in the planning phase to develop budgets and time tables which are subsequently used in the oversight process. These tools provide for a highly detailed reporting of each aspect and detail of the project to be monitored.

The management of these projects can involve a complex interaction between the project owner or stakeholder (the party which commissioned the project) and a group of Project Responsible Parties (PRPs) which include the contractors and other participants who have been hired under contract by the stakeholder to perform the work to complete the project or a portion thereof. Typically, the PRPs are responsible for periodically reporting the status and progress of the project to the stakeholder. Thus, PRPs gather data on a daily basis which reflects that amount of money spent, the materials used, the amount of time and degree of completion for each subproject or job as well as the project as a whole and prepare reports transmitted to the stakeholder which are intended to meet the reporting requirements of the contract. In some cases, the PRPs either have specialized internal organizations or hire outside third parties that perform the data gathering and reporting functions. In addition, independent auditors can be called in, from time to time to audit and certify the data gathering and reporting functions.

Accordingly, it is an object of this invention to provide an improved method and system for monitoring and reporting that status and progress of a project.

### SUMMARY OF THE INVENTION

The present invention is directed to a method and system for monitoring and reporting the status and progress of a project. In accordance with the invention, the project data which reflects the status and progress of the project is gathered and transferred to an independent data store that cannot be modified by the PRPs. This insures that the status and progress reporting functions are independent of the data gathering functions. The invention also includes a method and system which includes one or more rules that are used in the monitoring and reporting functions. The rules can be used to define variances in data points that are analyzed which result in the triggering of an event or the presentation of a status indicator. The data points can be data that is extracted directly from the source data, i.e. the project data, or the data points can be a function of the project data that is obtained from the source data. In addition, a rule or a set of rules can be defined which can use different types or sources of data or data points to trigger events or status indicators. The events can include the invocation of additional rules or processes that provide further analysis and/or status and progress monitoring and reporting functions.

The present invention is also directed to a method and system for presenting the status and progress of the project to the stakeholder. In accordance with the invention, the stakeholder can be provided with a customized display of the information concerning the status and progress of the project. The display can provide a single indicator of the status and/or the progress of the project to be monitored. The single indicator can comprise a colored indicator, wherein the different colors indicate different status levels or progress levels. Alternatively, the single indicator can include a set of symbols or icons, in which each symbol or icon is representative of a level of status or progress. Other indicators can include numeric values, words or terms that can be representative of the level of status or progress.

### BRIEF DESCRIPTION OF THE DRAWINGS

The foregoing and other objects of this invention, the various features thereof, as well as the invention itself, may be more fully understood from the following description, when read together with the accompanying drawings in which:

FIG. 1 is a diagrammatic view of a system in accordance with the invention;

FIG. 2 is a diagrammatic flowchart of a method in accordance with the invention; and

FIGS. 3-5 are diagrams of forms of the presentation dashboard in accordance with the invention.

### DETAILED DESCRIPTION OF THE PREFERRED EMBODIMENTS

The present invention is directed to a method and system for monitoring and reporting the status and progress of a project. In order to facilitate a better understanding of the invention, an illustrative embodiment of the invention, as applied to a construction project is set forth below. In the construction project of the illustrative embodiment, the stakeholder has contracted with several PRPs to complete the project that has been broken into several subprojects. The PRPs gather the data that is used for project status and progress reporting and an independent third party is tasked with reporting and presenting the status and progress of the project to the stakeholder.

The method and system according to the invention provide for the oversight and management of the project as a function of selected performance data, independent of the Project Responsible Parties (PRPs). As used herein, all the participants to a specific project or projects who have a contract with the Stakeholder entity are designated as the PRPs. The data being collected by these parties can include project data that relates to characteristics of the project, such as schedule or time; budget, cost and revenue; quality inspection; safety inspection; and other project related performance information. Preferably, the data being collected and the processing time is a clear contract requirement between the Stakeholder and the PRPs. The system and method in accordance with the invention can include comparing baseline estimates against actual quantities, which can be a combination of dollar, commodity or date quantities, and reporting variances between the actual quantities and the baseline estimate as well as trends as the project moves toward completion.

In accordance with the invention, the method and system provide for the electronic replication and transfer of project data from one or more client databases created and managed by the PRPs to an independent oversight server system database. The data transfer is uni-directional and the PRPs cannot modify the data in the independent oversight server system database. The data transferred is identical to the data that resides in the client database(s) as of the effective date of the data transfer. The oversight server system database is independent of all client server(s) and retains an accurate record of transferred project data at specific points of time and preserves the integrity of the imported data. Once the independent database system is populated, the data can be organized, analyzed, and/or selected in order to accomplish the data reporting and presentation functions.

In accordance with the invention, the method and system can electronically collect the data from one or more client databases contemporaneously and the oversight server system database can serve as a repository for contemporaneous project data and in effect become the general ledger of data transactions. Thus, the oversight server can collect the data as it is made available by the client databases, so that it is the most current and up-to-date data at the time it is collected. Alternatively, the project data can be collected from the client databases on regular or periodic intervals, e.g. the same time every day, week or month. This repository provides for the separation of the data entry function from the data analysis and the reporting functions in the independent oversight process.

The method and system according to the invention can measure actual project performance, forecast project performance and report project performance using a rules-based methodology. The rules can be defined and established by one or more Stakeholders in order to closely correspond to their reporting requirements. The rules can provide the baseline from which selected data variance analyses are performed. The data can be project data or data derived from project data. When the variance exceeds the range or criteria established by the rule, an indicator can highlight where actual and/or forecast performance exceeds the baseline or threshold values. In accordance with the invention, the system processes project data and generates performance indicator(s), which alerts the Stakeholder(s) on a variance or excessive variance from pre-established parameters, rules, or algorithms that define the expected project performance.

This status, progress and/or performance of the project can be presented through a customized user interface to highlight current and forecast performance against pre-determined project performance objectives. The user interface can include indicator(s), such as a symbol, colored light, flag, sound, or any other alphanumeric or symbolic designation that notifies the Stakeholder whether the current and/or forecast performance is or is not in compliance with one or more of the predetermined rules established for that project. The method and system in accordance with the invention provide for a rules-based presentation that includes exception indicators to indicate management action. The rules based presentation can provide a presentation system analogous to a performance indicating dashboard. The performance dashboard can restrict the stakeholder to read-only access to the original data. In addition, through the performance dashboard the stakeholder can model possible scenarios and can simulate performance through modifying model variables as a means to forecast potential impacts on project performance. The performance dashboard user interface can include a keystroke interface, a mouse interface, a touch-screen interface, a voice-activated interface, an eye-movement-activated interface, or any other user interfaces developed. The performance dashboard can function as an electronic tool for performing “real time” management oversight. The real time reporting capabilities of the system may be limited due to the data entry and data collection capabilities of the project. However, where PRPs provide real time project data that can be used to update the data used for performance monitoring and reporting (such as the independent oversight server database, although another non-independent system could be used), the system can provide real time monitoring and reporting functions.

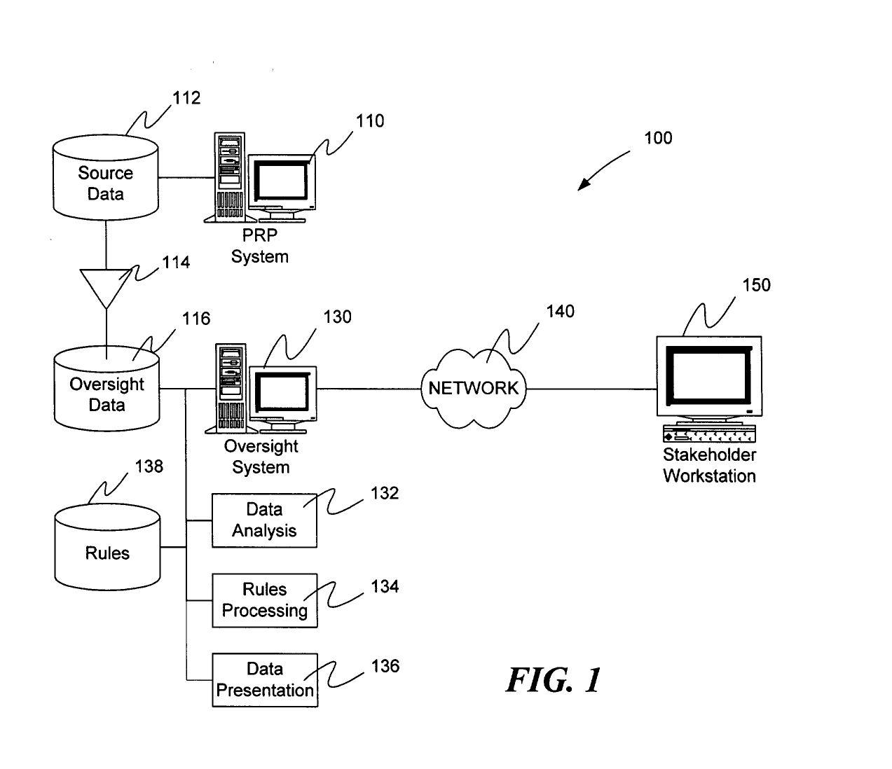

FIG. 1 shows a system 100 in accordance with the invention. The system 100 includes one or more PRP systems 110, a project source database 112, a data transfer system 114, an oversight database 116, an oversight system 130, a network 140 and stakeholder workstation 150. The oversight system 130 can include a data analysis component 132, a rules processing component 134, a data presentation component 136 and a rules database 138.

The PRP system 110 is adapted to collect the data relating to the performance of the project. Data can be collected manually (such as by manual data entry), semi-automatically (such as using barcode and magnetic stripe scanning systems) or automatically (such as electronic reporting and measuring systems, bank accounts, Electronic Data Interchange—“EDI”). While PRP system 110 is shown as a computer system, the PRP system 110 can be any device that provides for data entry including barcode and magnetic stripe scanning devices and handheld devices such as cellular telephones and so-called personal digital assistants (PDAs). The project data can be stored in a client project database 112 which can be in any accessible format. Preferably, the PRP system 110 is an IBM compatible personal computer configured with the Windows Operating system (available from Microsoft Corp., Redmond, Wash.). The PRP system can include a commercial database such as Access (available from Microsoft Corp., Redmond, Wash.) or an SQL database, or a proprietary system for collecting data can be provided. The project data can be stored in a project database 112 that serves as a central repository for all PRPs or each PRP can maintain its own project database for the project or portion of the project that it is managing.

The system 100 further includes a data transfer system 114 that is adapted for replicating the project source database 112 in the oversight database 116. Where the project includes several project source databases 112, the data transfer system 114 can be adapted for replicating each project source database 112 in the oversight database 116. In accordance with the invention, the data transfer system 114 can include a system and a procedure by which the data from the project source database 112 is replicated in the oversight database 116. The data transfer system 114 can be as simple as a function that copies the project source database 112 and transmits the copy to the oversight database 116 or it can include a more complex database replication process. The data transfer system 114 can be adapted or configured to collect the project data from the source database on a periodic basis, for example, a daily basis or the data can be collected in real time as it changes. While, the data transfer system 114 can be adapted to replicate all the data in the project source database or databases 112, it is not essential to the invention that all the data is transferred to the oversight database 116. Where oversight is only required or being provided for a portion of a project, only the project data concerning the portion of the project being monitored need be replicated at the oversight database 116.

The oversight database 116 provides an independently controlled data source for the project data. As a result, if the project data is changed between the extractions from the source database 112, the oversight database 116 can reflect the change as the difference in data between extraction transactions. In this regard, the oversight database 116 serves as the general ledger of data transactions of the project. The system 100 can further be provided with tools that allow the data to be audited, for example, on a transaction by transaction basis to identify anomalies and errors in the project data.

The oversight system 130 can be connected to the oversight database 116 via any data connection, including a direct physical connection, a local area network, a storage area network or any wired or wireless communication technology. The oversight system 130 and the oversight database 116 can be connected to the stakeholder workstation 150 via a network 140 or any wired or wireless communication technology. The oversight system 130 can also include an analysis component 132 that is adapted for processing and analyzing the data stored in the oversight database 116 as may be necessary to provide the management and oversight reporting functions. The rules processing component 134 is adapted to apply the rules to either data stored in the oversight database 116 or data derived (such as by analysis component 132) from data stored in the oversight database 116. The data presentation component 136 can interact with the rules processing component 134 in order to determine the state of the indicators provided in the performance dashboard. The oversight system 130 can also include a rules database 138 that can be used to store the rules used by the rules processing component 134 and the data presentation component 136 to report the status, progress and/or performance of the project to the stakeholder. The data analysis component 132, the rules processing component 134, the data presentation component 136 and the rules database 138 can reside on the oversight computer system 130 or they can each reside on a separate computer system that is connected to the others, such as via a private network or a public network, such as the Internet.

Depending upon the size of the oversight database 116 and number of stakeholder workstations 150 which can access the oversight system 130, the oversight system 130 can be run on a Microsoft Windows based desktop computer or a more powerful server computer (or cluster of server computers), operating under Windows 2000 Server or a Unix or Linux based Server. The oversight database 116 can be an SQL database that resides a Microsoft SQL Server 2000. The oversight system 130 can include a web server (such as Microsoft Internet Information Server) and be adapted to provide the project status, progress and performance reports as web pages accessed by a secure, access controlled transaction between the web server and the stakeholder workstation 150. Alternatively, a separate web server (not shown), such as Microsoft Internet Information Server can be located between the oversight system 130 and the network 140.

The stakeholder workstation 150 can be any system that can access the oversight system 130, such as a Microsoft Windows based personal computer with a web browser. The stakeholder workstation 150 can be connected to the oversight system 130 via a wired or wireless connection such as the Internet or a private network. The oversight system 130 can include a web server module (not shown) and be adapted to present the project status, progress or performance information in the form of one or more web pages. The stakeholder workstation 150 can be any web enabled device including, for example, a personal computer, a personal digital assistant (PDA) or a web enabled cellular telephone. Alternatively, the status, progress and/or performance can be simply reported in the form of a non-interactive display, such as an email message, or instant message, facsimile message or other report provided by a non-interactive media. In one embodiment, the stakeholder can simply receive a fax or an email which identifies those projects or subprojects which have an exception or a variance which exceeds the defined limits. The message can omit those projects or subprojects that do not have exceptions or variances.

In an alternative embodiment, the project status, progress and/or performance reporting function can be accomplished using a dedicated application that produces reports in the project dashboard format. The dedicated application can reside on the oversight system 130 and the stakeholder workstation 150 can be connected to the oversight system 130 via a secure connection, such as a direct physical connection or a virtual private network connection. Alternatively, the dedicated application can reside on the stakeholder workstation 150 and receive presentation data from the oversight system 130 which can be used to generate the project reports.

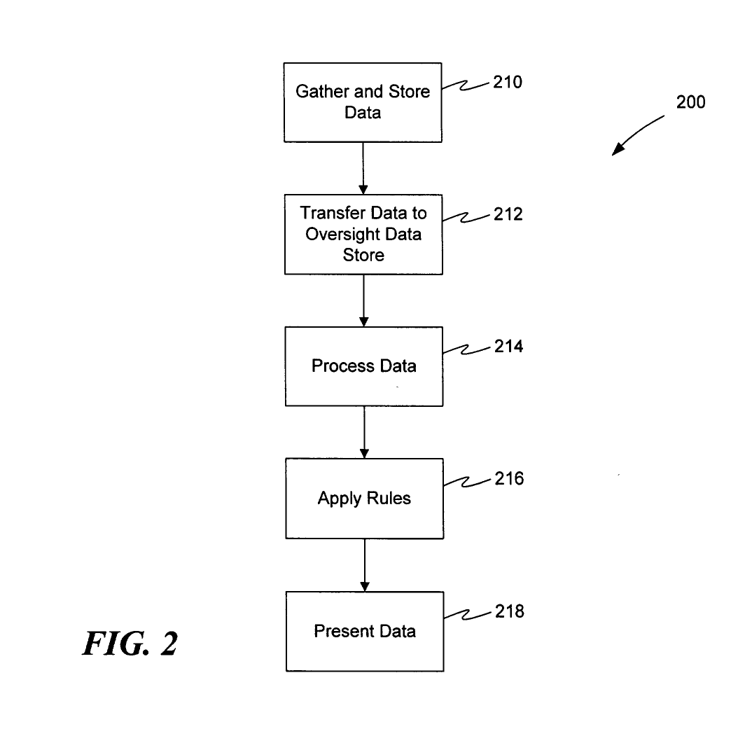

The method 200 according to the invention for monitoring and reporting the status and progress of a project can include the steps of applying the rules to the data to produce information representative of the status, progress and/or performance of the project and presenting the information representative of the status, progress and/or performance of the project to the stakeholder. As shown in FIG. 2, the method 200 can include the steps of gathering and storing the project data 210, transferring the project data to the oversight data store 212, processing the data 214; applying the rules to the data in the oversight data store 216, and presenting information representative of the project's status, progress or performance to the stakeholder. The data can be gathered by the PRPs, the stakeholder or a third party. Where the stakeholder or a third party gathers the data, there may not need to be the step of transferring the data the oversight data store 212 as the data can be directly input by the stakeholder or the third party into the oversight data store. In addition, it may not be necessary to further process the data at step 214, (except for retrieving or selectively retrieving the data used by a particular rule) if the data that is gathered and stored in a form in which the oversight system 130 can directly apply the rules to the data. Thus, where the data is gathered and stored at step 210 in a format that permits the rules to applied to the data at step 216 without any further transfer or processing and the steps of transferring the data 212 to an oversight data store and further processing the data 214 can be omitted. It is anticipated that each rule is not going to require all the data to apply the rule, thus the system at step 214 will need to process the data in that it will selectively retrieve (from wherever it is stored) the data need to for each rule. In some cases many data elements will be need, and in other cases only a few data elements will be needed. In step 218, the data can be presented to a user of the system. In accordance with the invention, at one level of the presentation, the performance of the project as a function of the project data can be presented to the user as a single indicator, symbol or icon. The single indicator, symbol or icon can represent to the performance of one or more characteristics of the performance of the project with respect to one or more predefined rules. The rules can defined baseline values and rule variances which can be applied to select project data to determine whether the project data varies from the baseline and whether the variance is significant (greater than the rule variance) such that the user would consider the variance to outside the acceptable range or require the user to take some action.

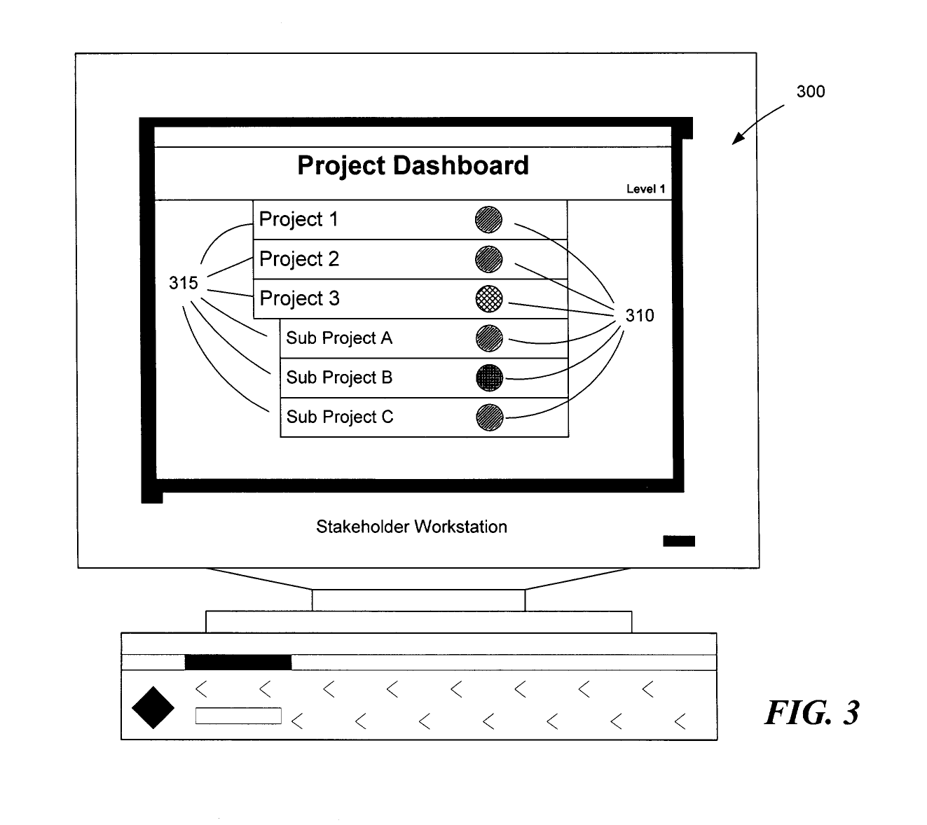

FIGS. 3-5 show a method and system for presenting information representative of the status, progress and/or performance of the project. This information can be determined by applying the rules to the project data. For example, for any project and each subproject, there can be an associated budget and a contingency for unexpected issues. In accordance with the invention, the current dollar estimate for a subproject can be compared against the baseline dollar estimate that was used for budget planning purposes. Through a mathematical computation the variance between the current and baseline estimate is calculated. This calculated variance can be used to forewarn the stakeholder of its exposure relative to its baseline estimate. The stakeholder can take any of the following actions: ignore the issue, modify scope, adjust the program budget immediately, implement appropriate control mechanisms to ensure meeting the program budget objective. This forewarning permits the stakeholder to consider alternative management actions before the final dollar value is committed. Table 1 below provides an example that concerns cost related metrics where the current estimate exceeds the baseline by $300,000.

TABLE 1

| Baseline Estimate | Current Estimate | Variance |
|---|---|---|
| $500,000.00 | $800,000.00 | $300,000.00 |

Alternatively, in an example that pertains to time-related metrics, the actual installation rate can be compared against its planned installation rate. This rate may be, for example, represented in terms of dollars per time unit or commodities per time unit. The measured rate may be across multiple objectives or across a single program objective. Table 2 below provides an example that concerns time related metrics where the actual rate is less than the planned rate by $4000 per month.

TABLE 2

| Planned Rate ($/month) | Actual Rate ($/month) | Variance ($/month) |
|---|---|---|
| 20,000.00 | 16,000.00 | 4,000.00 |

In accordance with the invention, a rule-based method can be applied wherein the variance calculation is compared against one or more pre-determined tolerance levels for the calculated variance. The comparison of the calculated variance and the tolerance level can trigger one or more system algorithms or processes that enable the variance to be represented in the dash board as a visual or audible performance indicator. The rule, which can be defined by the stakeholder, can reflect the target expectations during project execution and can provide variability in alerting management by clearly identifying any exception. The variability may be a range of values around the target expectations, values above or below the target expectations, or any combination thereof. In addition, the system can provide that the rules can change over time such that a the variance or tolerance level can change over the course of the project or as a function of prior actual data or estimates of future data that can be revised over time. Table 3 below provides some examples of the application of rules to the variances determined in Tables 1 and 2 above.

TABLE 3

| Rule Variance | Exceeds Rule | Indicator Status |
|---|---|---|
| $300,000.00 | YES | ON |
| $5000.00 | NO | OFF |

In accordance with the invention, the information representative of the status, progress and/or performance of the project can be presented in a dash board format as shown in FIGS. 3-5. FIG. 3 shows a first level of a dash board 300 which includes a single indicator 310 that is representative of the status, progress and/or performance of several projects and subprojects 315. As shown, the indicators 310 associated with Project 1, Project 2, Subproject A and Subproject C are a predefined color (such as green) and show that no variance has been exceeded or is expected to be exceeded at the current time. The indicators associated with Project 3 (shown in a different color such as yellow) and Subproject B (shown in yet another color such as red) indicate that a variance within the project has been or is likely to be exceeded. This form of presentation of information allows the stakeholder to view all the projects and subprojects and quickly assess which items require further consideration.

If none of the indicators indicate a variance or exception, the stakeholder can confidently move on to reviewing other projects. However, where, as in our example, several variances were indicated, the stakeholder can, in accordance with the invention, investigate the source of the variances by “drilling down” into the information used to produce the indicators in order to identify the source of the variance or exception. Where the project dash board is presented on a web page, for example, the web page can be configured to allow the stakeholder to click on the project name (e.g. Project 1) or the indicator to “drill down” or view the next level to view more detailed information about the specific project. The next level can display all the elements or subprojects that are part of the project and contribute to the reporting indicator of the project. Alternatively, the system can selectively present only those elements or subprojects that exceed there variances resulting in the project being, for example, over budget or not on schedule. The next level can be presented on a web page that provides several indicators, each representative of different aspects of the project or subproject being reviewed, such as the budget, the schedule, the safety or the inspection/approval of the project or subproject. Alternatively, project dashboard can be configured to present different levels of displays depending upon the status of the indicators on the previous level. For example, where a project does not indicate a variance or exception, the drill down function can bring the stakeholder to a second level which presents indicators of the individual aspects of the project or subprojects that where considered in the presenting the previous level, whereas when a project indicates a variance or exception, the drill down function can immediately bring the stakeholder to the web page the presents the specific aspect of the project or subproject that indicated or is the basis for the variance or exception.

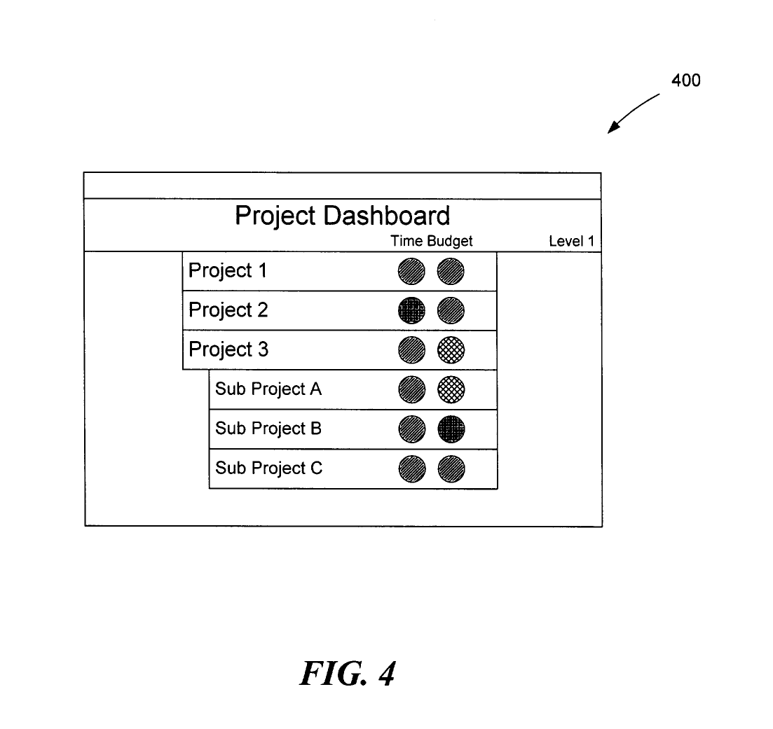

FIG. 4 shows an alternative embodiment wherein the project dashboard 400 shows the individual elements or aspects of the project for which rules have been defined and applied to the project data. Thus, for example the status of both the time schedule and the budget for each project and subproject can be presented together. In this embodiment, the stakeholder can define the project elements or aspects that are to be monitored and the status, progress or performance of each separate element can be presented as a separate indicator. Similar to the embodiment above, the stakeholder can review the details of each element on a separate screen or separate level.

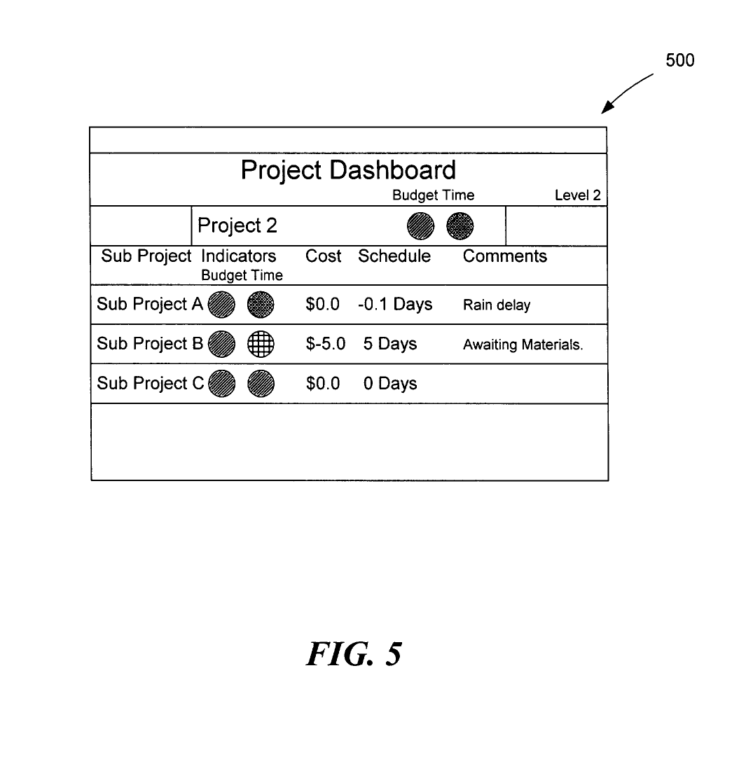

FIG. 5 shows a second level of a project dashboard 500, in which the project being reviewed (e.g. Project 2 of FIG. 4) has indicated a variance or exception (for example, by a red indicator) in the time schedule. The second level of the project dashboard can include more detailed information about each of the subprojects that make up a given project. In our illustrative example, Subproject A (shown, for example, with a red time indicator) is one source of the variance in the time schedule showing that 0.1 days have been lost, based upon the comment, probably due to rain. The illustrative example also shows, with respect to Subproject B that there is a positive variance or exception (shown, for example, by a yellow indicator) in this subproject, specifically the subproject is 5 days ahead and is $5000 under budget. Alternatively, the positive variance can be indicated by another color, such as blue, in order to distinguish it from yellow which indicates a negative variance. Note that the budget indicator has not changed, probably because the $5000 variance is below the level that would change the budget indicator, but that the time schedule indicator did change (to indicate a positive variance), probably because the 5 day variance exceeds the level that would change the time schedule indicator. The comment also indicates that subproject B is awaiting materials, suggesting that if the subproject might stay ahead of schedule if materials could be delivered within the 5 day lead.

In an alternative embodiment, the project dashboard can use symbols or icons that represent the status of a characteristic of a project. For example, a set of arrows, up arrow indicating a positive variance, a horizontal arrow indicating no variance and a down arrow indicating a negative variance. A set of symbols or icons, such as a thumbs up, thumbs down can be used. In addition, at any given level of presentation, where the symbol is a function of a variance, the symbol can be presented along with one or more numeric values indicating, for example, planned baseline, the variance defined by the rule, variance according to the project data; and/or how the project data deviates with respect to the baseline and/or the variance.

In accordance with the invention, the method and system can include additional steps or processes that can be used to extract the source data from the project or client database and convert it to a format that facilitates analysis and/or the application of the rules which provide for the dash board reporting. Attached hereto as Appendices A through J are specifications for a system and method in accordance with the invention. Appendices A and B include a flow chart and a description of an alternative method for processing the project data from a client database. Appendices C and D provide a description of a system architecture in accordance with the invention. Appendix E provides a description of system for transferring data from the source database to the oversight database in accordance with the invention. Appendix F provides a description of a system for presenting data in accordance with the invention. Appendix G provides a description of system security in accordance with the invention. Appendices H, I and J provide a description of the data structures and designs for a system in accordance with the invention.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for processing project data to determine project performance, said method comprising:
defining at least one rule for evaluating the project data,
storing project data in a data storage device,
processing said project data,
applying said at least one rule to said project data, and
presenting a status indicator representative of the performance of said project as a function of said rule and said project data.

2. The method according to claim 1 wherein said project data is stored on a periodic basis.

3. The method according to claim 1 wherein said status indicator is a symbol representative of at least one performance characteristic of said project.

4. The method according to claim 1 wherein said status indicator represents at least one performance characteristic of said project as a function of color.

5. The method according to claim 1 wherein processing said project data includes selectively retrieving said project data from the data storage device.

6. The method according to claim 1 wherein applying at least one rule to said project data includes comparing a predefined rule variance value to said project data.

7. The method according to claim 1 wherein applying at least one rule to said project data includes determining a difference between a predefined baseline value and said project data.

8. The method according to claim 1 wherein applying at least one rule to said project data includes determining a difference between a predefined baseline value and said project data and comparing said determined different with a predefined rule variance.

9. The method according to claim 1 further comprising:
receiving on a periodically, said project data from a project data source;
storing said project data, as it was received from said project data source in said data storage device, wherein said data storage device is an oversight data store which cannot be modified by said project data source.

10. A system for processing project data to determine performance of a project comprising:
data storage means for storing project data,
a rules processing system adapted for applying at least one rule to said project data, and
a data presentation system adapted for presenting an indicator representative of the performance of said project as a function of said at least one rule and said project data.

11. The system of claim 10 wherein said status indicator is a symbol representative of at least one performance characteristic of said project.

12. The system of claim 10 wherein said status indicator represents at least one performance characteristic of said project as a function of color.

13. The system of claim 10 further comprising a data processing system for processing said project data prior to applying said at least one rule to said project data.

14. The system of claim 10 wherein said rules processing system is adapted for comparing a predefined rule variance value to said project data.

15. A system of claim 10 determining a difference between a predefined baseline value and said project data.

16. The system of claim 10 wherein said rules processing system is adapted for determining a difference between a predefined baseline value and said project data and comparing said determined different with a predefined rule variance.

17. The system of claim 10 further comprising:
a data source for producing said project data,
means for transferring said project data from said data source to said data storage means, wherein said project data stored in said data storage means can not be modified by said data source.

18. A method for storing project data comprising:
producing project data at a project data source,
transferring said project data from said project data source to a data oversight data store,
preventing said project data source from modifying said project data stored in said data oversight data store.

19. The system of claim 18 wherein said project data source periodically produces project data and said project data is periodically transferred to said data oversight data store.

20. The system of claim 19 wherein said project data is transferred to said data oversight data store as soon as it is produced.

21. A system for storing project data comprising:
a project data source adapted for producing project data,
a data transfer system adapted for transferring said project data from said project data source to a data oversight data store,
said data oversight data store being adapted to prevent said project data source from modifying said project data stored in said data oversight data store.

22. The system of claim 21 wherein said project data source is adapted for periodically producing project data and said data transfer system is adapted for periodically transferring said project data to said data oversight data store.

23. The system of claim 22 wherein said transfer system is adapted to transfer said project data to said data oversight data store as soon as it is produced.
